(19) United States
(12) Patent Application Publication
(10) Pub. No.: US 2001/0013699 A1
(43) Pub. Date: Aug. 16, 2001

(54) DATA-DISPLAY ARRANGEMENT

(76) Inventor: PETER GARTISER, STARNBERG (DE)

Correspondence Address: MICHAEL J MCGOVERN, QUARLES & BRADY, 411 EAST WISCONSIN AVE, MILWAUKEE, WI, 532024497

(21) Appl. No.: 09/125,950

(22) PCT Filed: Feb. 22, 1997
(86) PCT No.: PCT/EP97/00859

§ 371 Date: None

(30) Foreign Application Priority Data
Feb. 28, 1996 (DE) 196 07 445.2

(51) Int. Cl. B42F 21/00

(52) U.S. Cl. 283/36

(57) ABSTRACT

An arrangement, particularly in the form of a catalogue, for the representation of a plurality of products contains a product part, in which all the products are indicated successively with an individual description on consecutively numbered pages.

To facilitate access to the individual products, the catalogue firstly contains a general summary, in which are arranged the use cases in a two-dimensional representation in accordance with the possible values of two independent parameters. The two-dimensional summary contains for each use case a reference to a group summary, which once again contains several possible sub-uses occurring under a particular use. For each sub-use, the suitable products are indicated by naming and page number. With the aid of the page number, the user can arrive in the product part, where he then finds the individual details on the product suitable for his specific use case.

The invention is based on a catalogue, in which a plurality of products is described in detail.

In books, catalogues or other compilations contents lists and indexes are known. A contents list normally gives the content of the catalogue in a single-dimensional representation in the same order as in the catalogue. Indexes give sources for alphabetically arranged catchwords.

In order to find a specific product, which is unknown at the outset, it is either necessary to read through the entire contents list and then guess where the product could be. In order to seek it in an index, it is necessary to know the catchword.

In certain applications approval certificates exist. Thus, e.g. for a specific fastening or fixing only a specific dowel may be used, which has undergone an approval process. The approval generally also takes place for specific applications only. One dowel can appear similar to another dowel which is not approved in the particular case. The distinction possibly only results from a model designation. An incorrect choice can here lead to serious disadvantages.

A tool catalogue is already known (DE 295 01 219), in which the pages are printed with columns and rows, symbols being positioned in the intersection or crossing area which refer to fold-out sheets.

An information book formed from several partial books is also known (DE 87 08 054). A contents list relates to the partial books. The book pages are not provided with a consecutive page numbering.

A marking system for printed matter is also known (WO 92/06850), in which on a following page is contained an optical representation of the first pages on a reduced scale.

The problem of the invention is to provide an arrangement for the representation of products, in which a user can more easily and reliably be guided to a suitable or prescribed product for the specific case he has in mind.

For solving this problem, the invention proposes an arrangement having the features given in claim 1. Further developments of the invention form the subject matter of subclaims.

The arrangement according to the invention makes it possible for a user, to obtain a summary of the content of the information from the two-dimensional general summary. The two-dimensional summary has the advantage that a larger information quantity can be surveyed at a glance. On the basis of the choice of a group from the general summary, the user can then create in the group summary a summary of the group chosen by him and here once again e.g. a double page of information is available. He can make a second choice from said group summary. He is then led to the individual product description, where he then acquires all the necessary data on the selected product.

Such an arrangement is not only suitable to give the user of the product, without prior knowledge, simple instructions as to where he can get the product, it can also serve as a training basis for the sales person.

In particular, it can be provided that the arrangement for information or data representation is implemented in a catalogue, particularly a bound catalogue. In place of a catalogue, it is also possible to use a loose leaf collection or a group of index cards. In such cases the individual pages are e.g. consecutively numbered, so that the reference from the group summary to the product part can take place with the aid of page numbers.

It is also possible for the product pages, group summary and general summary to be pages representable on a display screen and for the references from the general summary to the group summary and from the group summary to the product part to be formed by automatable links between the pages. For example, a user of the arrangement can pass from the general summary to the group summary in that he types the cell or element of the matrix-like display with a light pen, a mouse or in the case of pressure-sensitive screens directly with the finger and then the associated page appears on the screen.

According to a further development of the invention, several individual representations are contained in the representation of each group. If one group represents a specific type of application, then in the group representation can appear e.g. pictorial representations of several application cases. For each application case, the associated product with its designation or also only with the page number can be provided.

For example, the parameters of the general summary can be use parameters of the products, i.e. parameters indicating for which uses or applications a specific product is suitable. Conversely this can be expressed in such a way that from a specific use it is possible to arrive at the associated product.

The groups of the group summary can also be groups of uses, which further subdivide a specific use from the general summary.

It is also possible for the groups of the group summary to be product groups. Such an arrangement is particularly advantageous if the catalogue user already has certain prior knowledge.

According to a further development of the invention, the group summary for each cell of the matrix-like general summary, i.e. for each intersection of two possible parameter values, has its own entry or item. This entry can e.g. be contained on a double or single page and optionally can again comprise several representations of individual cases.

This means that each cell of the general summary refers to a different entry in the group summary.

It is also possible and is proposed by the invention, that the group summary for each row or each column of the general summary has an entry, so that the group summary becomes somewhat smaller. Such an arrangement can be particularly advantageous if the user is assumed to have a certain prior knowledge.

In order to also take account here of the second parameter, according to a further development of the invention, within an entry there is a distinction on the basis of possible values of the in each case other parameter.

In order to make it particularly easy to find a specific use case without frequent leafing forwards and backwards, according to the invention the values of the parameter are represented by optically distinguishable features. Different values of a parameter are then represented by different optical features. For example, it is possible to use a more or less pronounced patterning or screening, or a more or less wide hatching for the different parameter values.

In the case of the matrix-like overall representation in the general summary, according to the invention each cell is characterized by a combination of two optically distinguishable features.

According to the invention, the optical features can be repeated in the group summary. Thus, if in the general summary the user has chosen a specific feature combination, then the optical characteristic used in this cell is repeated on the sheets of the group summary, so that the user, without any page number, can use the optical features for orientation purposes.

It is conceivable for the same features to be used for the parameter values of both parameters contained in the general summary. However, it is particularly advantageous if all the values of both parameters differ in their optical characterizations.

A particularly suitable feature for optical distinction purposes is colour.

As the cells of the matrix in each case contain combination values of features, according to the invention, the parameter values are represented by optically characterized surfaces and the feature combinations by in particular geometrically similar surfaces divided along a line. If e.g. the optical characterization of a value of one parameter is the colour blue, then said parameter is only characterized by a blue surface. If a value of the second parameter assumes the value “yellow”, then it is characterized by a yellow surface. The combination of the two parameter values of the two parameters would then be characterized by a surface, which is partly yellow and partly blue. The dividing line can e.g. be a diagonal in a rectangle.

According to the invention, the reference from the general summary to the group summary can have a page number of the group summary. The use of page numbers has the advantage that it is possible to roughly estimate where opening has to take place in order to arrive at the corresponding page number. However, it is obviously possible to also have an orientation on the basis of optical features.

Additionally, the reference in the general summary can already have a word naming of use cases and/or products.

It is particularly favourable if, according to a further development of the invention, the catalogue has two general summaries with references to in each case a separate group summary. This makes it possible to permit access to the catalogue part with the individual product descriptions in two different ways, e.g. on the one hand by means of a representation of use cases and on the other by group formations under specific products.

It is possible for the two general summaries to be subdivided according to the same parameters, whereas the group summaries are subdivided according to different criteria.

When using two general summaries, it is in particular possible to take account of the fact that the catalogue is to be used by persons with different knowledge levels. One of the general summaries is then intended for the user with limited prior knowledge, who must then be led to his product with the aid of numerous use samples, more particularly in drawn or photographed form. The other general summary can then be used for a user with considerable knowledge, who is consequently given a more detailed general summary. He can therefore be somewhat more precisely informed at a first glance.

The catalogue makes it possible to place all products possible for a specific branch in one catalogue. If products are offered for different branches, it is possible to have a separate catalogue for each branch and all catalogues are then built up in the same way. In this case, the invention proposes that in each catalogue is contained an identical reference to all the other catalogues, the specific catalogue considered being optically stressed or emphasized.

According to the invention, the general summary and the group summary can be placed in a catalogue part to be leafed through and optionally also separately consecutively numbered compared with the product part. It is then possible to leaf through the two catalogue parts independently of one another, which is advantageous for rapid finding purposes.

A catalogue can e.g. be built up in such a way that the rear catalogue cover of the catalogue part containing the general summary and group summary forms the front book or catalogue cover of the product part or the general catalogue.

Further features, details and advantages can be gathered from the claims, whose wording is made by reference into part of the content of the description, the following description of a preferred embodiment of the invention and the attached drawings, wherein show:

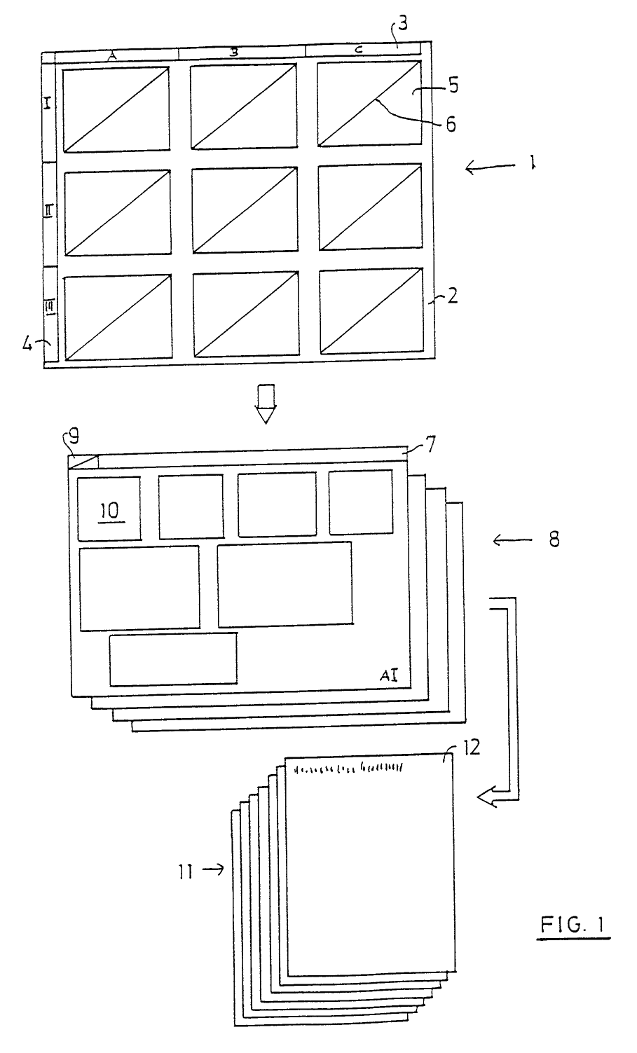

FIG. 1 A diagrammatic representation of a catalogue with a general summary, several group summaries and the product part.

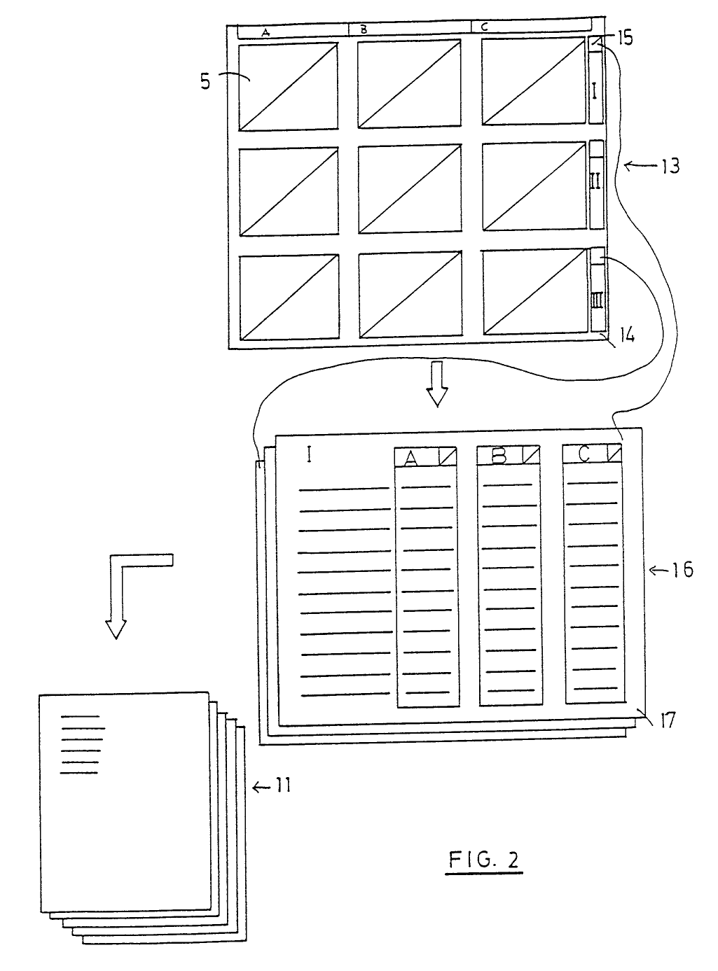

FIG. 2 A diagrammatic representation of a second type of arrangement with a modified group summary.

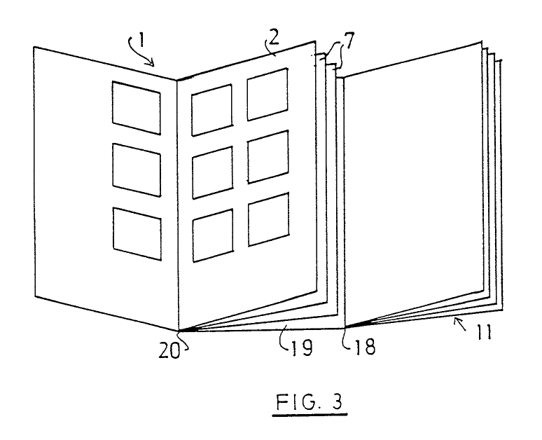

FIG. 3 The structure of a catalogue with general part and product part to be leafed through separately.

At the top of FIG. 1 can be seen a general summary 1 for a catalogue. This general summary 1 is e.g. printed on one catalogue page 2 or forms the leader for a loose leaf work. This sheet 2 can form a double page and can e.g. constitute an end paper for a catalogue. Along the upper edge of the sheet 2 of the general summary 1 is provided a strip 3, on which appear the three possible values A, B and C of a first parameter. For each parameter value is provided a field, which roughly represents a third of the sheet width. Each field can be characterized with a specific patterning or screening, or preferably with a specific colour, the colours for all three values A, B and C differing.

Along the left-hand edge of the sheet 2 is also printed a strip 4, in which appear three different values I, II and III of a second parameter, preferably also in a field having a specific colour. The two parameters are independent of one another, so that nine different combinations of the two parameters are possible. For each of these nine possible combinations a cell 5, which is constructed as a rectangle, is printed in the matrix-like representation. Each rectangle has a diagonal 6, on whose one side appears the colour value of one parameter and on whose other side appears the colour value of the other parameter for this cell. The nine cells are consequently represented by rectangles with nine different colour combinations.

For example by means of a page number or solely by the colour combination of the two colours on either side of the diagonal 6, in each cell 5 of the general summary 1 is contained a reference to an element formed by a sheet 7 of the group summary 2 represented in the centre of FIG. 1. Thus, from each cell 5, the user comes by a clear reference to precisely one sheet 7 in the group summary 8. At the top left of each sheet 7 of the group summary 8 is printed on a smaller scale a rectangle 9, which contains the same colour combination as the cell 5. At the right bottom of the drawing is again provided the combination of the two parameters. In the represented example the top sheet 1 of the group summary carries the designation AI, i.e. represents the sheet corresponding to the cell 5 top left of the general summary 1. This sheet 7 carries pictorially or in words several individual representations 10, e.g. use or application cases. The products usable for a specific use case are then characterized alongside or in the field 10 by their designation and a page number.

With the aid of the page number, the user then arrives in the product part 11 of the catalogue, which is represented in the lower third of FIG. 1 as a stack of sheets 12. These sheets 12 are consecutively numbered and in each case contain an individual product description.

From the general summary I and with the aid of the information provided there, the user in each case arrives at a particular sheet 7 of the group summary 8, where he can seek the specific product, whose individual description he can find in the product part 11. The user can obviously arrive at the same product from several individual use cases or also from several sheets 7, because as a rule the products are suitable for numerous applications.

An example of products which can be contained in such a catalogue are fastening elements. Then, e.g. the values A, B and C could represent the ceiling, wall or floor, whereas the values I, II and III would represent different materials for the ceiling, wall or floor, e.g. concrete, lightweight building material and masonry.

For his specific case, the user would seek from the general summary 1 and with the knowledge of the material and the type of fastening, the corresponding use case, e.g. C2. He would pass from there to a specific sheet 7 of the group summary 8, where he would find, under the several possible use cases, a naming of the products required, including their page number. With the aid of the page number, he can now seek the specific individual description of the product, select there its dimensions and finally order the product on the basis of an order number.

The same process can also be performed by a sales person, who wishes to train himself in order to find the correct product for specific use cases.

FIG. 3 diagrammatically shows a second possibility, where a user, without any significant knowledge of the product, can arrive at the correct product.

The arrangement for finding a specific product once again contains a general summary 13, which appears on its own individual sheet 14. Here again the several values of the two independent parameters appear in rows and columns and the cells can represent a specific use case. The colour designation takes place in the same way as in the embodiment of FIG. 1. However, in order to bring about a faster success on the part of a user who already has a certain knowledge and in principle knows the products, each row of cells 5 contains in the strip on the right-hand edge a reference 15 to the same entry in the group summary 16. However, in the individual cells 5 of each row there are different inscriptions or headings, which once again apply to the values A, B and C.

An entry in the group summary 16, which is once again contained on a sheet 17, e.g. contains to the left a listing of products and in the right-hand three columns, in each case one column for each value A, B and C of the first parameter. The left-hand list can e.g. contain the page number for the product part, whereas the three columns can contain additional information for the values A, B and C, e.g. whether a specific product is suitable, which diameter is required for the specific case and so on. In this arrangement, as shown in FIG. 2, the somewhat better informed user, with the aid of an entry in the group summary 16, is provided with a survey of three groups of applications, i.e. a somewhat better survey. The reference in the catalogue part 11 takes place in the same way as for the embodiment according to FIG. 1.

On considering FIGS. 1 and 2 together, it can be seen that the general summary 1 to 13 is built up according to the same criteria and that ultimately there is a reference to the same product part 11. Only the group summary 16 has a somewhat different structure, namely an entry is provided for each line of cells 5 of the general summary.

The invention proposes that both access types to the product part are provided in one catalogue.

It is obviously also possible to have an arrangement according to FIG. 2 in such a way that for each column of the matrix-like general summary, there is one group summary entry. It is also conceivable for one catalogue to offer these three access possibilities.

FIG. 3 shows in greatly simplified form the structure of a catalogue according to the invention. The catalogue contains two catalogue parts, namely the product part 11, in which the individual sheets are combined along a common back 18 to form a catalogue.

On the usually free edge 20 of the front cover 19 of the catalogue are provided once again the sheets 7 forming the group summary 8 in the manner of a book or booklet, so that the edge 20 of the front catalogue cover 19 simultaneously forms a back. This can also be expressed in such a way that the general summary and group summary are combined into a catalogue, whose back cover simultaneously forms the front cover of the product catalogue. The general summary 1 is placed on the end paper of the summary catalogue part. This type of arrangement has the advantage that the user, initially following orientation in the general summary, can leaf through the group summary part until he has found his particular application. He then folds open this application and can then leaf at random within the product part. This obviates the leafing through to a further extent in the summary part, so that the opened product part virtually forms a bookmark for the summary part of the catalogue.

Hereinbefore the arrangement for information or data representation has been explained by means of a catalogue for a specific use case, namely fastening elements, e.g. dowels. In the horizontal direction in the matrix-like survey are given the values for the point at which the dowel is to be used, namely e.g. ceiling, wall or floor. Then, in the vertical arrangement, are provided the different materials from which the ceiling, wall or floor can be made.

Hereinafter will be explained a second use case, namely the use of sealants. Here, it is horizontally possible to provide the requirement possibilities for the sealant and in the vertical direction the fields of use. The requirement would e.g. be constituted by the values: expansion joint inside, connection joint outside, expansion joint outside, connection joint inside. As uses could be given the materials with which the sealants are to cooperate, e.g. the values: concrete, masonry, tiles, plaster, wood, glass, natural stone, metal and plastic.

In this way, a matrix-like representation is obtained, in which the user, with the knowledge of the requirements and the material of the use is guided to a specific point in the matrix, namely a cell, from where he can reach the associated group summary.

As the third, relatively simple use example of the proposed invention is provided the product “saw”. Horizontally, in the corresponding matrix, are given the different types of saw, e.g. fret saw, sabre saw, oscillating saw, manual circular saw and power hacksaw.

Vertically, can be given the material to be worked by the corresponding saw, e.g. wood, metal, plastic, as well as miscellaneous tools.

A similar representation would e.g. be possible for drills, in which the point angle is dependent on the material in which drilling is to take place.

1. Information representation arrangement, particularly of products, having
1.1 a product part (11),
1.1.1 having pages and
1.1.2 in which successively appear all the products to be represented with an individual product description,
1.2 a group summary (8, 16), in which
1.2.1 are given groups of products belonging together under one standpoint and
1.2.2 for each selected product a reference to the page of the product part (8, 16) with the individual product description, as well as with
1.3 a general summary (2, 13),
1.3.1 where, in a matrix-like representation, are given the possible values (A, B, C) of a first parameter of the products in a first dimension and
1.3.2 the possible values (I, II, III) of a second parameter, in partic ular independent of the first parameter, in a second dimension and
1.3.3 in the cells (5) of the representation is contained a reference to a group of the group summary (8, 16).

2. Arrangement according to claim 1, wherein the general arrangement is formed by an in particular bound catalogue, a loose leaf collection or a group of index cards.

3. Arrangement according to claim 1, in which the product pages, the group summary (8, 16) and the general summary (2, 13) are pages representable on a screen and the references are formed by automatable links between the pages.

4. Arrangement according to one of the preceding claims, wherein several individual representations are contained in the representation of each group.

5. Arrangement according to one of the preceding claims, wherein the parameters of the general summary (2) are use parameters of the products.

6. Arrangement according to one of the preceding claims, wherein the groups of the group summary (8) are use groups.

7. Arrangement according to one of the claims 1 to 5, wherein the groups of the group summary (16) are product groups.

8. Arrangement according to one of the preceding claims, wherein the group summary for each cell (5) of the general summary (1) has its own entry.

9. Arrangement according to one of the claims 1 to 7, wherein the group summary (16) has an entry for each row or column of the general summary (13).

10. Arrangement according to claim 9, wherein, within an entry, there is a distinction on the basis of the possible values of the in each case other parameter.

11. Arrangement according to one of the preceding claims, wherein the parameter values (A, B, C, I, II, III) are represented by optically distinguishable features.

12. Arrangement according to claim 11, in which each cell (5) of the general summary (1, 13) is characterized by a combination of two optically distinguisable features.

13. Arrangement according to claim 11 or 12, wherein the optically distinguishable features are repeated in the group summary (8, 16).

14. Arrangement according to one of the claims 11 to 13, wherein different features are used for the parameter values of both parameters.

15. Arrangement according to one of the claims 11 to 14, wherein colour is used as a distinguishing feature.

16. Arrangement according to one of the claims 11 to 15, wherein the parameter values (A, B, C, I, II, III) are represented by optically characterized surfaces and the feature combinations by in particular geometrically similar surfaces separated along a line (6).

17. Arrangement according to one of the preceding claims, wherein the reference from the general summary (1, 13) to the group summary (8, 16) has a page number of the group summary (8, 16).

18. Arrangement according to claim 17, wherein the reference from the general summary (1, 13) to the group summary (8, 16) has a list of use cases and/or products.

19. Arrangement according to one of the preceding claims, wherein there are two general summaries (1, 13) with references to in each case one group summary (8, 16).

20. Arrangement according to claim 19, wherein the general summaries (1, 13) are subdivided according to the same parameters and the group summaries (8, 16) are subdivided according to different criteria.

21. Arrangement according to one of the preceding claims, with a reference to similarly constructed catalogues for other use branches.

22. Arrangement according to one of the preceding claims, wherein the general summary (1, 13) and group summary (8, 16) are in a catalogue part to be leafed through separately from the product part (11) and which is optionally separately consecutively numbered.

23. Arrangement according to claim 22, wherein the back catalogue cover (19) of the catalogue part containing the general summary (1, 13) and group summary (8, 16) forms the front book cover of the product part or the overall catalogue.
